(19) United States
(12) Patent Application Publication
(10) Pub. No.: US 2010/0014000 A1
(43) Pub. Date: Jan. 21, 2010

(54) Automatic Color Adjustment Method and An Automatic Color Adjustment Device

(76) Inventors: Chueh-Pin Ko, Tapei Hsien (TW); Chen-Kang Su, Taipei Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/260,141

(22) Filed: Oct. 29, 2008

(30) Foreign Application Priority Data
Jul. 16, 2008 (TW) 097126944

(51) Int. Cl. H04N 5/57

(52) U.S. Cl. 348/603; 348/E05.119

(57) ABSTRACT

An automatic color adjustment method and an automatic color adjustment device used for an image output device are disclosed. The method comprises the following steps: obtaining an accumulated usage time of the image output device; obtaining the color intensity decline value corresponding to the accumulated usage time; and adjusting the color intensity of the image output device according to the color intensity decline value.

### BACKGROUND OF THE INVENTION

1. Field of the Invention

The present invention relates to an automatic color adjustment method and an automatic color adjustment device, and more particularly, to an automatic color adjustment method and an automatic color adjustment device for an image output device.

2. Description of the Related Art

Generally speaking, the color of an image output device (e.g. LCD monitors, projectors) will start to decay, deviate from its original color, and start to exhibit distortion after the device has been used for a period time. For example, as the light bulb of a projector is used for a period of time, its light intensity will gradually decrease and the colors will start to turn yellowish. A similar problem exists for the light emitting diodes and the organic light emitting diodes which are used in LCD panels and organic displays, respectively.

In the prior art, technology exists that allows detection of the lighting information of an LCD by means of a sensor; the lighting information detected is sent back to the LCD for the adjustment of the light source. However, this method incurs a higher manufacturing cost, and the lighting information detected is not always accurate.

Other technology also in the prior art allows pre-recording of the relationship of the light intensity and the usage time. After the lighting information of an image output device is detected, it is compared to the pre-recorded values, and the light intensity is adjusted accordingly in order to restore its original state. Although this method allows adjustment of the light intensity of the image output device, it does not allow color adjustment; also, by increasing the light intensity of a decayed light source, it in turn decreases the life span of the image output device.

Therefore, an automatic color adjustment method and an automatic color adjustment device are needed so as to solve the above mentioned problem.

### SUMMARY OF THE INVENTION

An object of the present invention is to provide an automatic color adjustment method for an image output device.

Another object of the present invention is to provide an automatic color adjustment device which can perform automatic color adjustment for an image output device.

To achieve the first mentioned objective, the present invention presents an automatic color adjustment method comprising the following steps: obtaining an accumulated usage time of the image output device; obtaining color intensity decline values corresponding to the accumulated usage time; and adjusting the color intensity of the image output device according to the color intensity decline values.

In order to achieve the second mentioned objective, the present invention presents an automatic color adjustment device comprising a timer, a data storage unit, a comparison module, and a color control module. The timer is used to obtain the accumulated usage time of the image output device; the data storage unit is used to store the color intensity decline values; the comparison module is used to obtain the color intensity decline values corresponding to the accumulated usage time, and the color control module is used to adjust the color intensity of the image output device.

According to one embodiment of the present invention, the color intensity decline values include a red intensity decline value, a green intensity decline value, and a blue intensity decline value. The color intensity includes a red intensity, a green intensity, and a blue intensity. The color control module is used to adjust the red intensity, the green intensity, and the blue intensity to the same level of intensity.

### BRIEF DESCRIPTION OF THE DRAWINGS

FIG. 1 shows a structural diagram of the automatic color adjustment device of the present invention.

FIG. 2 shows a flow chart of the automatic color adjustment method.

FIG. 3 shows a relational-curve of the color intensity decline values with respect to time.

FIG. 4 shows the color intensity decline values at various accumulated usage times.

FIG. 5A shows the color intensity decline values at various accumulated usage times after the color intensity has been adjusted.

FIG. 5B is another embodiment which shows the color intensity decline values at the accumulated usage times after the color intensity has been adjusted.

### DETAILED DESCRIPTION OF THE PREFERRED EMBODIMENT

The advantages and innovative features of the invention will become more apparent from the following preferred embodiments.

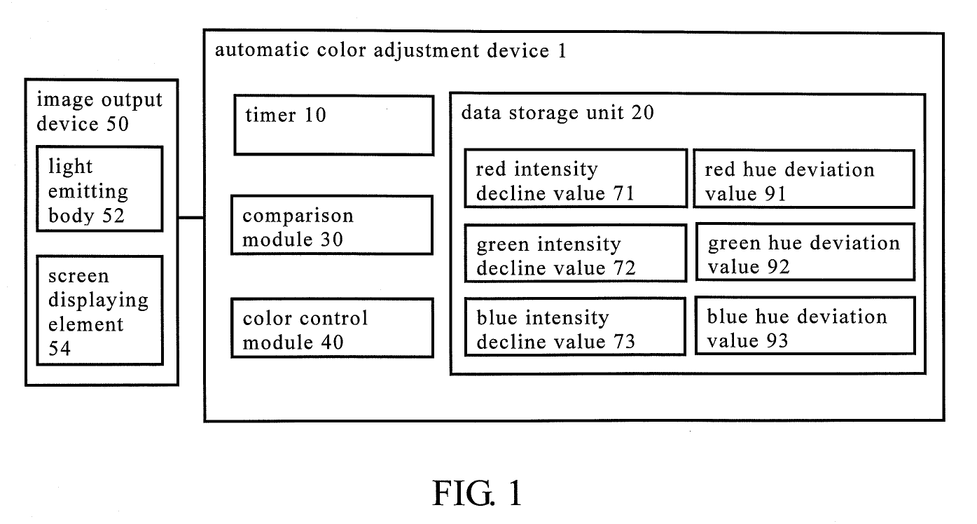

Refer to FIG. 1, which shows a structural diagram of an automatic color adjustment device for the present invention. An automatic color adjustment device 1 is used to adjust the colors displayed by a image output device 50 automatically. The automatic color adjustment device 1 can be installed externally to the image output device 50, and these two devices can be connected to each other through electric coupling; the automatic color adjustment device 1 can also be installed within the image output device 50.

The image output device 50 can be an LCD display or a projector. The image output device 50 comprises a light emitting body 52 and a screen displaying element 54, wherein the light emitting body 52 is used as the light source of the image output device 50, wherein the screen displaying element 54 is used as an adjusting element before the images are displayed. It must be emphasized that the light emitting body 52 and the screen displaying element 54 of the image output device 50 can be of the same element. For example, the light emitting body 52 and the screen displaying element 54 can both be an organic light emitting diode (OLED) when the image output device 50 is an organic display.

When the image output device 50 is an LCD screen, the light emitting body 52 can be a cold cathode fluorescent lamp (CCFL) or a light emitting diode (LED); when the image output device 50 is a projector, the light emitting body 52 can be a high voltage halogen lamp or an LED. The screen displaying element 54 can be a liquid crystal display (LCD) unit or a digital micromirror device (DMD) unit.

The image output device 50 has a color intensity which is formed by the combination of the intensities of the following colors: red, green, blue, yellow, and white. In the present embodiment, the color intensity of the image output device 50 is represented by the intensities of the three primary colors, which includes red intensity 61, green intensity 62, and blue intensity 63. The intensities of these colors decay respective to accumulated usage time, and the rates of decay are different for each color; not only will this cause the light intensity to decrease, it will also cause the white balance of the overall image to deviate from the original balance.

The automatic color adjustment device 1 comprises a timer 10, a data storage unit 20, a comparison module 30, and a color control module 40. The timer 10 is used to obtain the accumulated usage time of the image output device 50; the accumulated usage time only includes the usage time of the image output device 50 and excludes the time while the device is switched off.

The data storage unit 20 is used to store the color intensity decline values. The color intensity decline values are formed by the combination of the color intensity decline values of the following colors: red, green, blue, yellow and white. In the present embodiment, the color intensity decline values of the image output device 50 with respect to time are represented by the three primary colors, which include red intensity decline value 71; green intensity decline value 72; blue intensity decline value 73; red deviation value 91; green deviation value 92; and blue deviation value 93. By obtaining these values, the condition of the color decay and the color deviation of the image output device 50 can be fully captured. However, the relationship of the color intensity decline values to the usage time varies for different types of image output device 50; this relationship can be obtained by solving equations or by pre-measuring the device.

Comparison module 30 is used to obtain red intensity decline value 71, green intensity decline value 72, blue intensity decline value 73, red hue deviation value 91, green hue deviation value 92, and blue hue deviation value 93 with respect to the accumulated usage time obtained so that the expected color displaying ability of the image output device 50 for any particular accumulated usage time can be known.

The color control module 40 is used to adjust the light emitting body 52 and/or the screen displaying element 54. According to the red intensity decline value 71, the green intensity decline value 72, the blue intensity decline value 73, the red deviation value 91, the green deviation value 92, and the blue deviation value 93 obtained, the color control module 40 can separately adjust the red intensity 61, the green intensity 62, the blue intensity 63, the red hue 81, the green hue 82, and the blue hue 83 of the image output device 50 accordingly to display the image with a preferable condition.

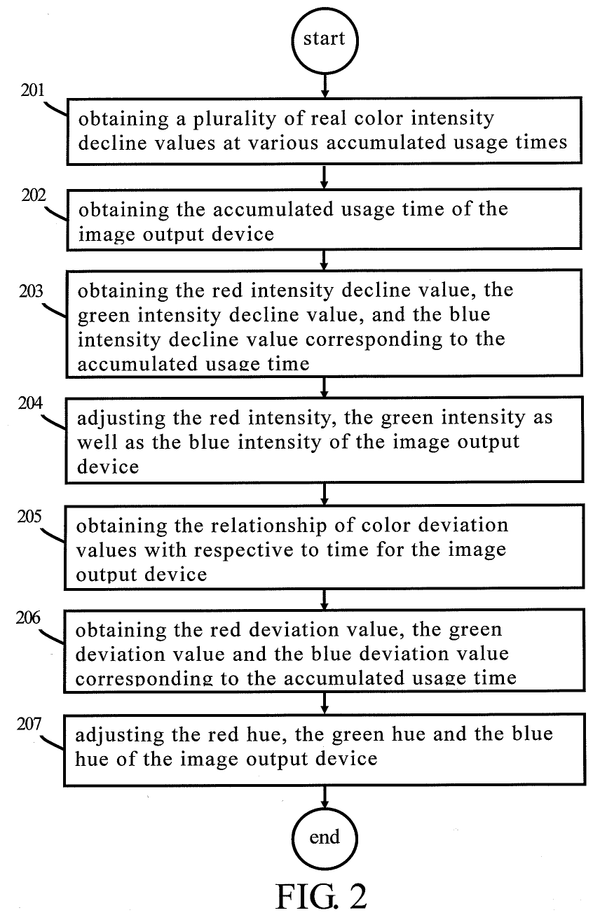

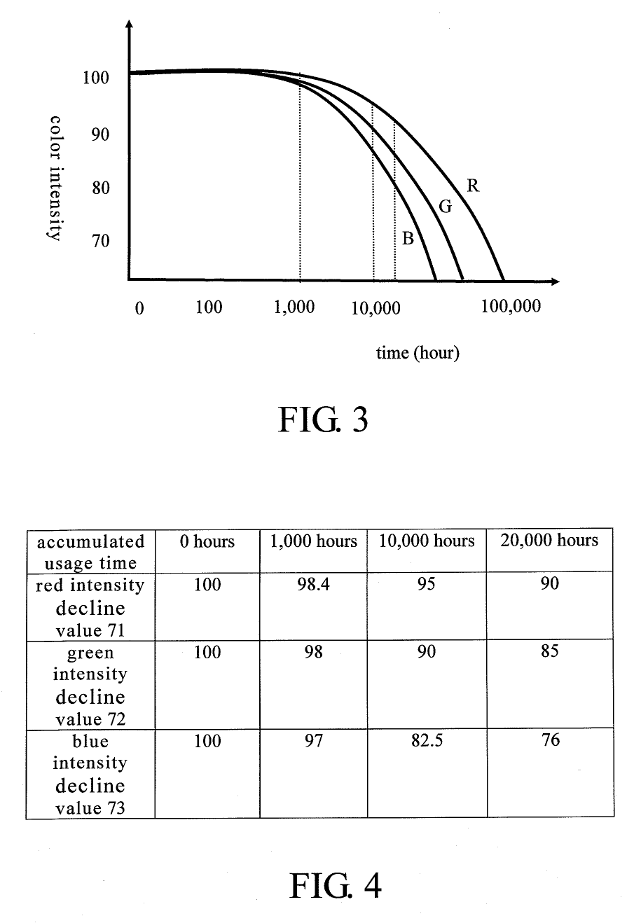

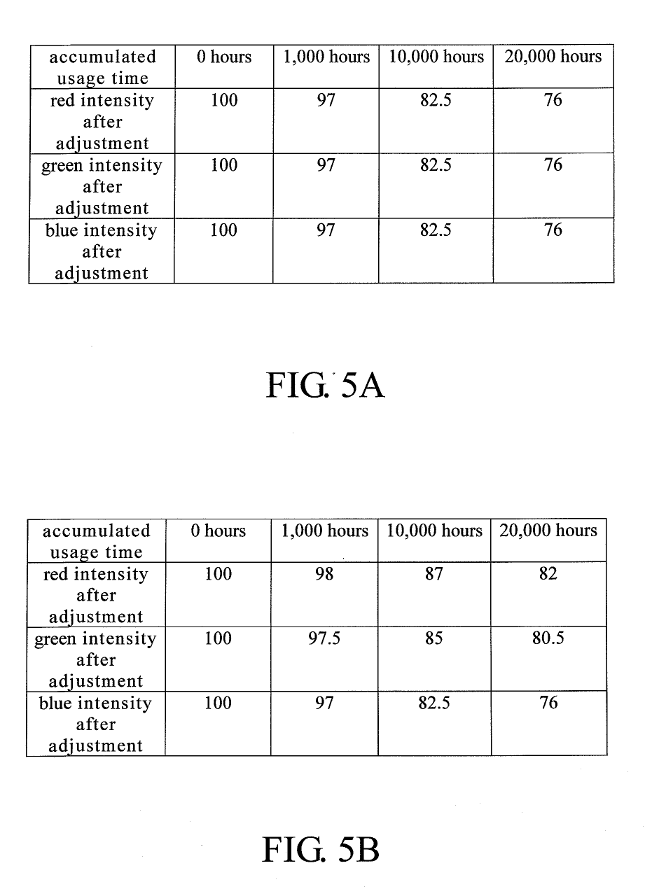

Refer to FIG. 2 and FIG. 5, which show embodiments of the automatic color adjustment method of the present invention in order to illustrate the actual operation of the automatic color adjustment device 1. FIG. 2 shows a flow chart of the automatic color adjustment method. FIG. 3 shows the relational-curve of the color intensity decline values with respect to time. FIG. 4 shows the color intensity decline values at various accumulated usage times. FIG. 5A shows the color intensity decline values at various accumulated usage times after the intensity has been adjusted. FIG. 5B is another embodiment which shows the color intensity decline values at various accumulated usage time after the intensity has been adjusted.

Please note that although the automatic color adjustment method is depicted according to the automatic color adjustment device 1 shown in FIG. 1, the present invention is not only limited to the device of the automatic color adjustment device 1.

As shown in FIG. 2, the automatic color adjustment method of the present invention comprises step 201 to step 207 and will be described in greater detail. First, the present invention proceeds with step 201: obtaining a plurality of real color intensity decline values at various accumulated usage times. In the present embodiment, the color intensity decline values include red intensity decline value 71, green intensity decline value 72, and blue intensity decline value 73; the color intensity includes red intensity 61, green intensity 62, and blue intensity 63.

In step 201, the plurality of real color intensity decline values at various accumulated usage times is obtained by the automatic color adjustment device 1, wherein the color intensity decline values are represented by the three theoretical primary colors, including a red intensity decline value, a green intensity decline value, and a blue intensity decline value. In the present embodiment, the plurality of real color intensity decline values at various accumulated usage times is obtained by pre-measuring the image output device 50; the information obtained is then stored in the data storage unit 20.

Refer to FIG. 3, which shows the relational-curve of the color intensity decline values with respect to time. According to FIG. 3, it can be seen that the rates of the color decay for red, green, and blue are different; the color blue has a faster rate of decay, whereas the color red has a slower rate of decay. This is the main reason that causes the image output device 50 to exhibit image distortion.

Refer to FIG. 3 and FIG. 4. The color blue is used as an example. The color intensity is 100 at 0 hours; the color intensity decreases to 97 after 1,000 hours; the color intensity decreases to 82.5 after 10,000 hours; and the color intensity decreases to 76 after 20,000 hours. Therefore, the color blue will gradually decay from a darker blue (high intensity) to a lighter blue (low intensity) as the image output device is used for a long period of time.

Next, the present invention proceeds with step 202: obtaining the accumulated usage time of the image output device. In step 202, the timer 10 of the automatic color adjustment device 1 is used to measure the accumulated usage time of the image output device; this information is then passed onto the comparison module 30 in order to proceed with step 203.

In step 203, the expected values of the red intensity decline value, the green intensity decline value, and the blue intensity decline value corresponding to the accumulated usage time are obtained. The comparison module 30 uses the accumulated usage time from step 202 and compares it with “the plurality of real color intensity decline values at various accumulated usage times” obtained in step 201, such that the corresponding red intensity decline value, the green intensity decline value, and the blue intensity decline value with respect to the accumulated usage time are obtained.

Please refer to FIG. 3 as an example. FIG. 3 shows that if the timer 10 has measured an accumulated usage time of 10,000 hours, the red intensity decline value 71 will be 95, the green intensity decline value 72 will be 90, and the blue intensity decline value 73 will be 82.5. Step 204 is adjustment of the red intensity, the green intensity, and the blue intensity of the image output device.

Next in the process is step 204. According to the red intensity decline value 71, the green intensity decline value 72, and the blue intensity decline value 73 obtained from step 203, the color control module 40 will separately adjust the red intensity 61, the green intensity 62, and the blue intensity 63 of the image output device to appropriate values, respectively. The color adjustment of the image output device 50 is achieved by means of the light emitting body 52 or the screen display element 54.

Wherein a light emitting body 52 is used for the adjustment process before the images are generated, the light intensity, level, and saturation can be adjusted by altering the voltage and the current of the light emitting body 52. For example, the light emitting body 52 can be a light bulb for a projector.

Wherein a screen displaying element 54 is used for the adjustment process after the images are generated, by tuning the screen displaying element 54, the light level, intensity, contrast, saturation, and tone of the image output device 50 can be adjusted accordingly. For example, the screen displaying element 54 can be a digital micro mirror device for a projector.

Please note that the color adjustment and the adjustment of the light emitting body 52 and the screen displaying element 54 can be performed at the same time.

The following passage describes two color adjustment methods. Refer to FIG. 4 and FIG. 5. FIG. 5A is an embodiment which shows the color intensity decline values of the accumulated usage time after the color intensity has been adjusted. In the embodiment, the red intensity 61, the green intensity 62, and the blue intensity 63 are adjusted to the same level of intensity; this is the process of white balance adjustment with respect to time.

For example, the lowest intensity from the set of the red intensity 61, the green intensity 62, and the blue intensity 63 is chosen, and all color intensities are adjusted to match the lowest intensity. In the present embodiment, the blue color has the fastest rate of decay of the three primary colors; therefore, the blue intensity is used as a benchmark; the red intensity 61 and the green intensity 62 will be thus adjusted to match the blue intensity 63. As a result, the colors of the image output device 50 can be restored to the preferred condition. As an example, the initial intensity ratio of the primary colors (red, green and blue) are 1:1:1. After 1,000 hours of usage, the ratio becomes 98.4:98:97; the color control module 40 can then adjust the color intensities to restore the intensity ratio of 1:1:1. As shown in FIG. 5A, the blue intensity is used as the benchmark; thus, the red intensity and the green intensity will be adjusted to match the benchmark. Please note that the red intensity or the green intensity can also be used as the benchmark, and that the intensity of the other colors must also be adjusted to match it.

Next refer to FIG. 4 and FIG. 5B. FIG. 5B is another embodiment which shows the color intensity decline values of the accumulated usage time after the color intensity has been adjusted. In this embodiment, when the blue intensity 63 has decayed for more than a predefined value, the red intensity 61 and the green intensity 62 will be adjusted and decreased to a certain degree, but not to a degree as low as that of the blue intensity 63. In other words, a weighting scheme will be applied to the intensity adjustment process, and the weighting will be varied respective to time. Since it is unnecessary for the red intensity and the green intensity to drop as low as the blue intensity when the blue intensity is over-decayed, this method will prevent the loss of light intensity. Although there will be some image distortion in the process, it will be controlled within an acceptable range; hence the balance between light intensity and color can be obtained.

Besides color decay, there will be color deviation and wavelength variation after the image output device 50 is used for a period of time. For example, the original green will gradually become a reddish green. In order to adjust the color deviation problem after the image output device 50 is used for a period of time, the present invention proceeds with step 205: obtaining the relationship of color deviation values respective to time for the image output device 50.

The relationship of color deviation values respective to time for the image output device 50 is obtained by the automatic color adjustment device 1; the color deviation values are represented by the three primary colors, including the red deviation value, the green deviation value, and the blue deviation value. In the present embodiment, the relationship of color deviation values respective to time is obtained by pre-measuring the image output device 50, and the information obtained is then stored in the data storage unit 20.

Please note that the relationship of the color deviation values respective to time of the image output device 50 can be obtained in step 201.

The process continues with step 206: obtaining the red deviation value, the green deviation value, and the blue deviation value corresponding to the accumulated usage time.

The comparison module 30 can make use of the accumulated usage time and compare it with “the relationship of color deviation values respective to time”, such that the red hue deviation value 91, the green hue deviation value 92, and the blue hue deviation value 93 of the corresponding accumulated usage time can be obtained.

Please note that the red hue deviation value 91, the green hue deviation value 92, and the blue hue deviation value 93 can be obtained in step 203.

Step 207 is used for adjustment of the red hue, the green hue, and the blue hue of the image output device. According to the red hue deviation value 91, the green hue deviation value 92 and the blue hue deviation value 93 obtained in step 206, the color control module 40 will adjust the red hue 81, the green hue 82 and the blue hue 83 of the image output device 50 to an appropriate value.

Please note that step 207 and step 204 can be completed at the same time. Please note also that if the objective of color adjustment is fulfilled by steps 201 to 204, then steps 205 to 207 can be omitted.

Although the present invention has been explained in relation to its preferred embodiment, it is also of vital importance to acknowledge that many other possible modifications and variations can be made without departing from the spirit and scope of the invention as hereinafter claimed.

What is claimed is:

1. An automatic color adjustment method for an image output device, wherein the automatic color adjustment method comprises the following steps:
obtaining an accumulated usage time of the image output device;
obtaining a color intensity decline value corresponding to the accumulated usage time; and
adjusting a color intensity of the image output device according to the color intensity decline value.

2. The automatic color adjustment method as claimed in claim 1, wherein the color intensity decline value is selected from the group consisting of a red intensity decline value, a green intensity decline value, a blue intensity decline value, a yellow intensity decline value, and a white intensity decline value; wherein the color intensity is selected from the group consisting of a red intensity, a green intensity, a blue intensity, a yellow intensity, and a white intensity.

3. The automatic color adjustment method as claimed in claim 2, wherein the color intensity decline value comprises a red intensity decline value, a green intensity decline value, and a blue intensity decline value, wherein the color intensity comprises a red intensity, a green intensity, and a blue intensity.

4. The automatic color adjustment method as claimed in claim 3 further comprising:
obtaining a plurality of real color intensity decline values at various accumulated usage times, wherein the color intensity decline value is selected from the plurality of real color intensity decline values.

5. The automatic color adjustment method as claimed in claim 4, wherein the red color intensity, the green color intensity, and the blue color intensity are adjusted to the same level of intensity.

6. The automatic color adjustment method as claimed in claim 5, wherein the weakest intensity of the red intensity, the green intensity, and the blue intensity is chosen and all other color intensities are adjusted to match it accordingly.

7. The automatic color adjustment method as claimed in claim 5, wherein the blue intensity is not adjusted; the red intensity and the green intensity are adjusted to match the blue intensity.

8. The automatic color adjustment method as claimed in claim 4, wherein the red intensity and the green intensity are adjusted and decreased to a certain degree, but not as low as that of the blue intensity when the blue intensity has decayed more than a predefined value.

9. The automatic color adjustment method as claimed in claim 3, wherein the automatic color adjustment method further comprises:
obtaining a hue deviation value with respect to the accumulated usage time; and
adjusting a hue of the image output device according to the hue deviation value.

10. The automatic color adjustment method as claimed in claim 9, wherein the hue deviation value is selected from the group consisting of a red hue deviation value, a green hue deviation value, a blue hue deviation value, a yellow hue deviation value, and a white hue deviation value; wherein the hue is selected from the group consisting of a red hue, a green hue, a blue hue, a yellow hue, and a white hue.

11. An automatic color adjustment device for an image output device, wherein the automatic color adjustment device comprises:
a timer, wherein the timer is used to obtain an accumulated usage time of the image output device;
a data storage unit, wherein the data storage unit is used to store a color intensity decline value;
a comparison module, wherein the comparison module is used to obtain the color intensity decline value corresponding to the accumulated usage time; and
a color control module, wherein the color control module is used to adjust the color intensity of the image output device according to the color intensity decline value.

12. The automatic color adjustment device as claimed in claim 11, wherein the color intensity decline value is selected from the group consisting of a red intensity decline value, a green intensity decline value, a blue intensity decline value, a yellow intensity decline value, and a white intensity decline value; wherein the color intensity is selected from the group consisting of a red intensity, a green intensity, a blue intensity, a yellow intensity, and a white intensity.

13. The automatic color adjustment device as claimed in claim 12, wherein the color intensity decline value comprises a red intensity decline value, a green intensity decline value, and a blue intensity decline value, wherein the color intensity comprises a red intensity, a green intensity, and a blue intensity.

14. The automatic color adjustment device as claimed in claim 13, wherein the red color intensity, the green color intensity, and the blue color intensity are adjusted to the same level of intensity by the control module.

15. The automatic color adjustment device as claimed in claim 14, wherein the weakest intensity of the red intensity, the green intensity, and the blue intensity is chosen and all other color intensities are adjusted to match it accordingly.

16. The automatic color adjustment device as claimed in claim 11, wherein the image output device includes a red hue, a green hue, and a blue hue, wherein the data storage unit stores a red hue deviation value, a green hue deviation value, and a blue hue deviation value, wherein the comparison module obtains the red hue deviation value, the green hue deviation value, and the blue hue deviation value corresponding to the accumulated usage time in order to adjust the red hue, the green hue, and the blue hue of the image output device.

17. The automatic color adjustment device as claimed in claim 11, wherein the image output device comprises a light emitting body and a screen displaying element, wherein the control module is used for adjusting the light emitting body or the screen displaying element.

18. The automatic color adjustment device as claimed in claim 17, wherein the image output device is an LCD, an organic display, or a projector; wherein the light emitting body is a cold cathode fluorescent lamp (CCFL), a light emitting diode (LED), a high voltage halogen lamp, or a organic light emitting diode (OLED); wherein the screen displaying element is a liquid crystal display (LCD), a digital micromirror device (DMD), or an OLED.
